(19) United States
(12) Patent Application Publication
(10) Pub. No.: US 2007/0168861 A1
(43) Pub. Date: Jul. 19, 2007

(54) Method for indicating completion status of user initiated and system created tasks

(76) Inventors: Denise Ann Bell, Austin, TX (US); Peter Kissa, Woodbridge (CA); Arnaud Airy Mathieu, Austin, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(21) Appl. No.: 11/333,520

(22) Filed: Jan. 17, 2006

(51) Int. Cl. G06F 3/01

(52) U.S. Cl. 715/701

(57) ABSTRACT

In a computing environment, a display shows the progress of the execution of a user or system initiated task. The display includes the current completion status of the task, and the completion results of the task. The completion results indicate the amount of the task that has been completed and indicates the results of the completion. This displays differs from conventional task status displays in that this display gives information about the progress of the task execution and the activities that occurred during the task execution.

### FIELD OF THE INVENTION

The present invention relates to a display that indicates the status of a tasks executing in a computing system environment and in particular to a display that indicates a current status of a task executing in computing system environment including an indication of the percentage of the completed and results of the completion at various phases of the execution.

### BACKGROUND OF THE INVENTION

Many tasks are executed on a computing takes various amounts of time to complete. Most computers have a display indicator to inform the user of the percentage of the task that has been completed and the amount of the task that remains. With the advent of the graphical user interface (GUI) on computer systems came the increasingly common practice of informing a user of the progress of any past or functions invoked by the user within the application. This practice has become popular because it is interactive with the user and keeps the user apprised of how the function or task invoked is progressing. Such a progress indicator has the advantage of informing the user that the function is in fact executing and is progressing to completion and it has the other advantage of letting users know how quickly a particular function may progress and this is particularly useful when a function takes a significant amount of time thus allowing the user to abort the function if necessary.

Many popular operating systems use a dialogue window to indicate the status of a function being performed by the computer. This window may indicate the status of the ongoing task in a variety of manners to the user. One example includes illustrating status using a “progress bar”, which contains a moving bar that grows in size to indicate a percentage of the task either already performed or left to be performed. Generally, a progress bar is an animation that indicates, by filling an empty space of a fixed size, that a certain percentage of a task has been completed, which corresponds to the percentage of the space filled in. Another indication mechanism, used to indicate status of a task to the user, may include a numerical indication of the estimated amount of time left for the task to be completed.

One problem with the status indication given to a user during a task is that often the percentage of the task already performed, or yet to be performed, does not progress in a regular manner. This may be the case for a variety of reasons. For example, a file may take longer than expected to copy because of the time required to access the data on the device where it is stored. It may also be possible that the computer has a large amount of high priority processor-intensive applications running concurrently with the task, thereby preventing continuous execution of the task. Other delays may be caused by communication speed degradation or communication interruptions.

Although status indicators can convey the status of the executing task, once the task has completed, status indicators do not display any information about the nature of the completed task. In some situations, an error message may indicate some problem with the execution of the task. However, there is nothing in the display that points to a potential cause of the error.

One way to address this situation would be to render these completion results in a pie-shape chart. However, the pie-shape charts are not compact enough and they require more UI estate to allocate. These charts can become ambiguous in cases when a user needs to compare the results or in the case when results are listed in the grid. A current problem is that the users may not be able to understand the impact of the overall tasks that have been initiated. This display of overall task status would help them determine if user intervention, or problem resolution is needed, or if a given task needs to be stopped to avoid unnecessary network flooding.

Although there are several methods for displaying task status information of a task executing in a computing system environment, there remains a need for a display method and system that can provide information about the current percentage of a task that has been completed, the percentage of the task that has been successfully completed and an identification of points in the completion of the task in which problems may have occurred in the execution of the task.

### SUMMARY OF THE INVENTION

It is an objective of the present invention to provide a display method and system that can display completion results for multiple tasks executing in a computing environment.

It is a second objective of the present invention to a display method and system that provide real-time completion status information of a currently executing task.

It is a third objective of the present invention to provide a display method and system that can indicate the occurrence of an error during the execution of a task such that a user can specifically observe where the error occurred during the task execution.

It is a fourth objective of the present invention to provide a method and system to track the history an executing task and determine trends in the execution of that task.

It is a fifth objective of the present invention to provide the ability to predict impending problems and initiate automated or manual actions as appropriate.

The present invention provides a display method and system that renders in a compact form, a comprehensive status of a functional task and its multiple operations' results during and after their execution of the task. This compact control allows the user to get a high level view of the overall completion status of the task.

In the present invention, display shows the user a task, the current completion status of the task, and the completion results of the task. The completion results indicate the amount of the task that has been completed and indicates the results of the completion. For example, if a task is 70 percent complete, the completion results would indicate that 70 percent of the task has been executed. In addition, the completion results would indicate if that 70 percent was successful or whether certain portions of that task experienced problems. If the task has five equal phases, at 70 percent the task would be in phase four. The status completion indicator may show that phases 1 through three were complete, but something happen in the execution of phase that generated a warning by the system. This warning would cover only a percentage of the completion results display and could have a different color or pattern scheme from the other portion of the completion results for the task. This different pattern or color would alert the user to some issue with that phase of the task, even if the issue does not cause the task to fail.

### DESCRIPTION OF THE DRAWINGS

FIG. 1 is an illustration of a computing network environment in which multiple tasks simultaneously occur.

FIG. 2 is a format for the display of status information for executing tasks.

FIGS. 3a, 3b and 3c illustrate the completion display column of the display of the present invention.

FIG. 4 is a view of a display in accordance with the present invention simultaneously showing the statuses of various executing tasks.

FIG. 5 is a view of a display in accordance with the present invention showing the execution status of subtasks for an executing task in FIG. 4.

FIG. 6 is a view of a detailed display of the activities of an executing task of FIG. 4.

FIG. 7 is a flow diagram of the method for displaying information related to the status and completion of executing tasks in accordance with the present invention.

FIG. 8 is a flow diagram of an alternate implementation of the method for displaying information related to the status and completion of executing tasks in accordance with the present invention.

### DETAILED DESCRIPTION OF THE INVENTION

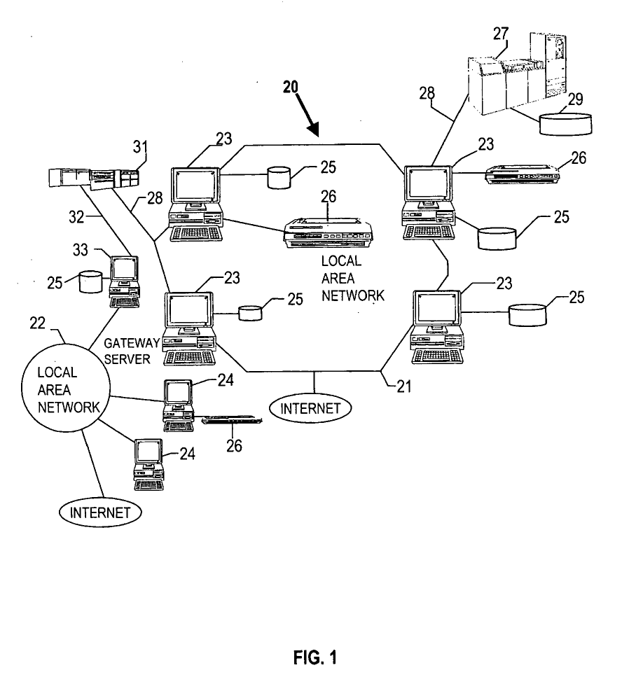

The implementation of the present invention can be within a computing system environment such as a distributed computing network. With reference now FIG. 1, there is depicted a pictorial representation of a distributed computer network environment 20 in which one may implement the display method and system of the present invention. As may be seen, distributed data processing system 20 may include a plurality of networks, such as Local Area Networks (LAN) 21 and 22, each of which preferably includes a plurality of individual computers 23 and 24, respectively. Any of the processing systems may also be connected to the Internet as shown. As is common in such data processing systems, each individual computer may be coupled to a storage device 25 and/or a printer/output device 26. One or more such storage devices 25 may be utilized, in accordance with the method of the present invention, to store the various data objects or documents which may be periodically accessed and processed by a user within distributed data processing system 20, in accordance with the method and system of the present invention. In a manner well known in the prior art, each such data processing procedure or document may be stored within a storage device 25 which is associated with a Resource Manager or Library Service, which is responsible for maintaining and updating all resource objects associated therewith.

Still referring to FIG. 1, the distributed data processing system 20 may also include multiple mainframe computers, such as mainframe computer 27, which may be preferably coupled to Local Area Network (LAN) 21 by means of communications link 28. Mainframe computer 27 may also be coupled to a storage device 29 which may serve as remote storage for Local Area Network (LAN) 21. A second Local Area Network (LAN) 22 may be coupled to Local Area Network (LAN) 21 via communications controller 31 and communications link 32 to a gateway server 33. Gateway server 33 is preferably an individual computer or Intelligent Work Station (IWS), which serves to link Local Area Network (LAN) 22 to Local Area Network (LAN) 21. As discussed above with respect to Local Area Network (LAN) 22 and Local Area Network (LAN) 21, a plurality of data processing procedures or documents may be stored within storage device 29 and controlled by mainframe computer 27, as Resource Manager or Library Service for the data processing procedures and documents thus stored.

As described a computing environment can have various processing devices, such as printers, computer, and storage devices that are all capable of executing tasks. In addition, tasks can be executed in these devices. Referring to FIG. 2, shown is an illustration of a task completion status display of various currently executing tasks. These tasks can be executing in any of the devices in the system. As shown, this display screen contains the statuses of multiple currently executing tasks. The display is in a chart form and has several columns, which indicate different information about the executing tasks. Column 40 indicates the name of the executing task. Column 42 indicates the platform on which the task is executing. Column 44 indicates the current status of the task. The typical task statuses can be completed, in progress or scheduled. The status can be represented by the stated words or symbols can be used to indicate these statuses. Column 46 displays the initiator of the task. Column 48 indicates the completion results of the executing task. This indication can be in the form of a bar for each task listed in column 40. Column 50 indicates the start time of the task.

Referring to column 48, the completion indication can be a color or pattern indicating the completion status of a percentage of the task. Each color or pattern would represent a particular status. With regard to colors, green could represent a successful execution of the task. Red could represent the failure of a routine or module to properly execute. This failure may not be enough for the entire task execution to fail. However, the user would know this fact. For example, if a task was loaded, but one module failed to properly load, the task may not function properly as a result of a malfunctioning module. From the completion results, the user would know approximately when the failure occurred and would probably be able to identify which module failed. At this point, the user may reinstall that module or take other appropriate action. Other colors could indicate additional statuses. Black could represent a complete failure of a task. Yellow could be a warning, which could mean that a module did load successfully, but exceeded the allotted time defined for that module to load.

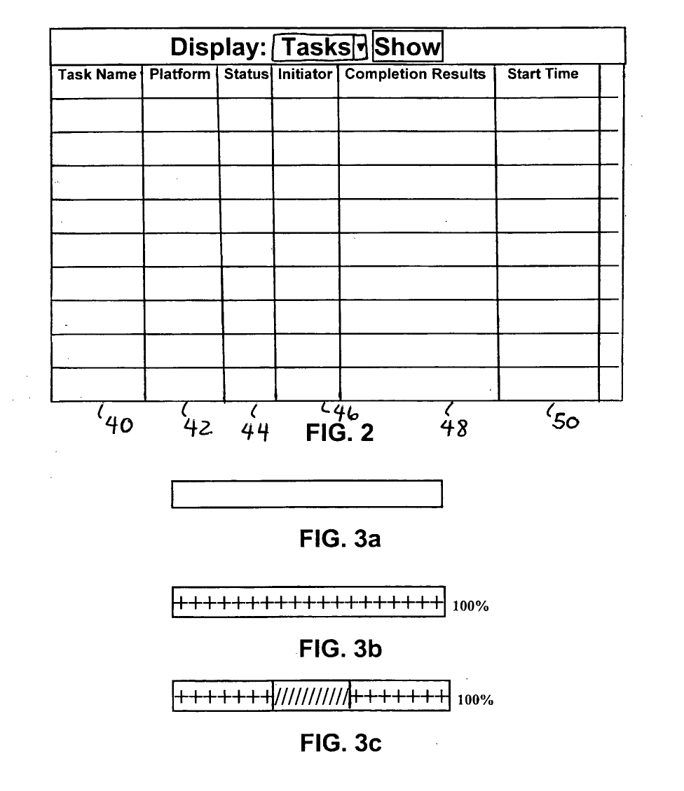

FIGS. 3a, 3b and 3c are examples of completion statuses indicated by a pattern. Referring to FIG. 3a, for a scheduled task, the display is completely clear or blank indicating no status. FIG. 3b indicates a completed task in that a pattern occupies the entire bar. The pattern will occupy a percentage of the bar that directly corresponds to the percentage of the task that has completed execution. This display can further indicate whether the completion was successful or whether there were problems with the execution of the task. For example, if the display in column 48 for a task was a solid green color for the entire bar, this could represent of a successful completion of the task. If the display in column 48 for a task had segmented colors or patterns as shown in FIG. 3c, this could indicated problems at certain points in the execution of the task. FIG. 3c begins with an initial symbol ‘+’ that represents a successful completion. At approximately 40 percent of the execution the pattern changes to a different symbol ‘///’ indicating a warning and at approximately 60 percent of the execution, the pattern shifts back to the symbol ‘+’ indicating successful completion. When the user views this pattern, the user will know that something abnormal occurred during the middle of the execution. An ‘x’ symbol in the bar could indicate the failure of a certain task routine to properly execute. In addition to the statuses shown in FIGS. 3a, 3b and 3c, the feedback provided in the completion results bar could indicate other statuses such as errors or failures. Each status would have a unique color or pattern indicating this status.

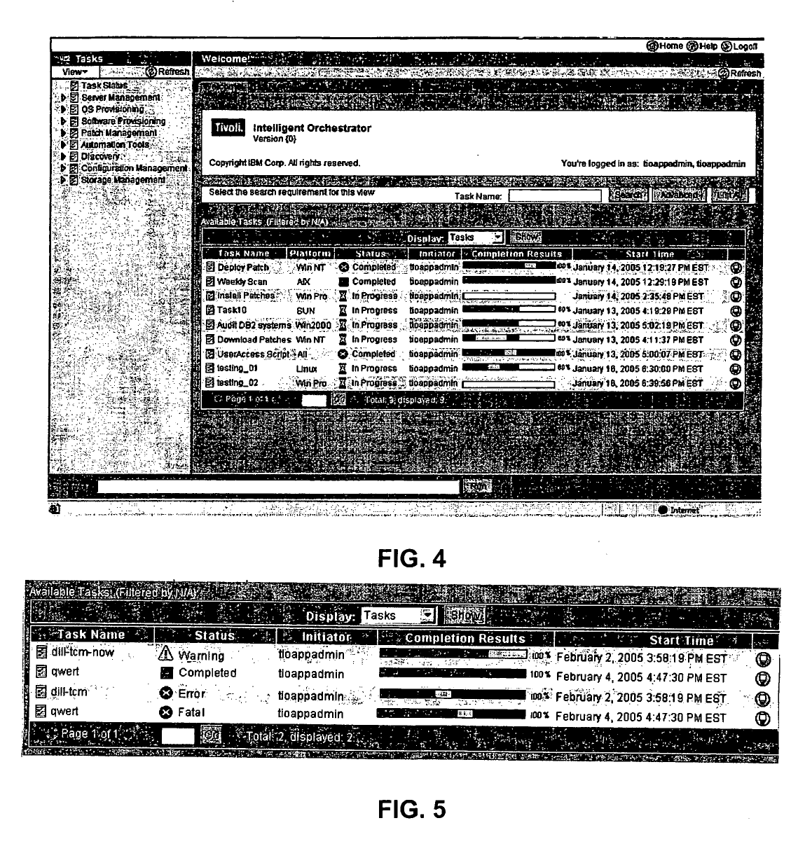

FIG. 4 is a view of an actual display in accordance with the present invention simultaneously showing the statuses of various executing tasks. This display shows nine tasks that are completed or are in process. Referring to task name ‘Deploy Patch’, the status is complete. However, referring to the status column 44, there can be an indicator showing that problems occurred during the execution of the task. This trouble is indicated by the dark X symbol adjacent the completed. Further the complete status column 48 also indicates a failure pattern at the end of the task execution. Although the task was completed, these indicators suggest to the user that something wrong occurred during the execution of the task. The problem did not terminate the task, but the user may need to give some attention to the problem. The completion results bar also indicate at what point in the execution, the problem occurred. Referring again to FIG. 4, the ‘Weekly Scan’ task has successfully completed its execution. The status column indicated a completed task and the adjacent icon indicates a successful completion as well. Further, the completion status bar shows a complete and consistent execution of the task. The ‘Install Patches’ task indicates a newly initialized task that has a status of ‘in process’. The completion results column has a bar that indicates the task has just begun to execute.

FIG. 5 is a view of a display in accordance with the present invention showing the execution status of subtasks for an executing task in FIG. 4. If the ‘Deploy Patch’ task has multiple subtasks, the statuses of these subtasks can be indicated in the same manner as the main tasks shown in FIG. 4. As shown, this task can have four subtasks. Display in FIG. 5 has the same columns and information for the subtasks as the main tasks. This display of FIG. 5 can be used display the details of the activities that occurred during the execution and to identify problems that occurred during the task execution. In one approach, when the user is viewing the FIG. 5 display, the user can move the mouse over an action or subtask and view specific details of the subtask in textual or numeric form in popup windows. These windows would appear over the display and contain information such the number of targets attempted, the number of targets that succeeded, the number of targets that failed, the number of timeouts and the number of canceled. The target devices can include mainframes, PC's laptops, handheld devices (PDA's), cellular telephones, and storage and network devices. If the task were to update a file on devices belonging to a sales department, each device would be considered a target. The user could access the activities of any of these target devices. The information would show if the information was successfully updated on that machine.

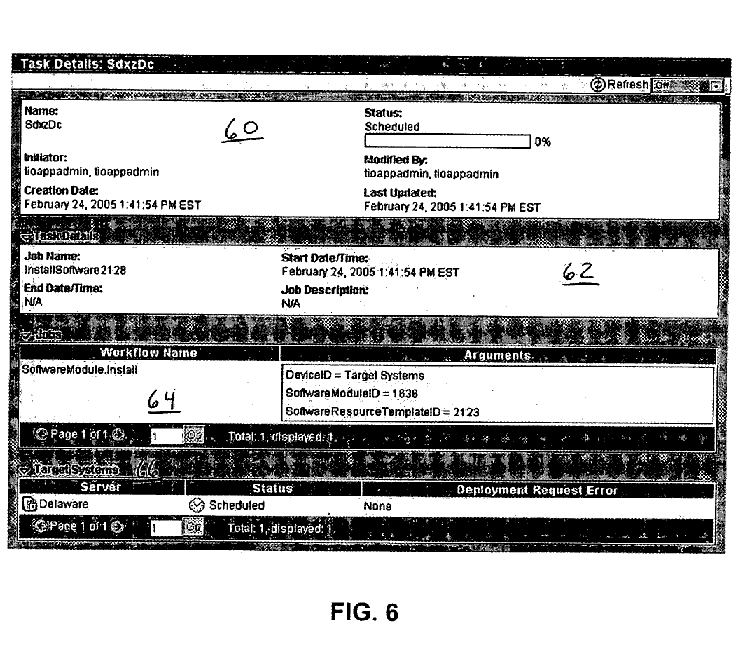

FIG. 6 is a view of a detailed display of the activities of an executing task of FIG. 4. The display contains a header section 60 with name of the task ‘SdxzDc’ and other status information as contained in FIG. 4. The Task Details section 62 includes the ‘Job Name’, ‘Job Description’ and the ‘Start Date/Time and End Date/Time’. The Jobs section 64 contains workflow information. The Target System section 66 contains server, status and deployment request error information.

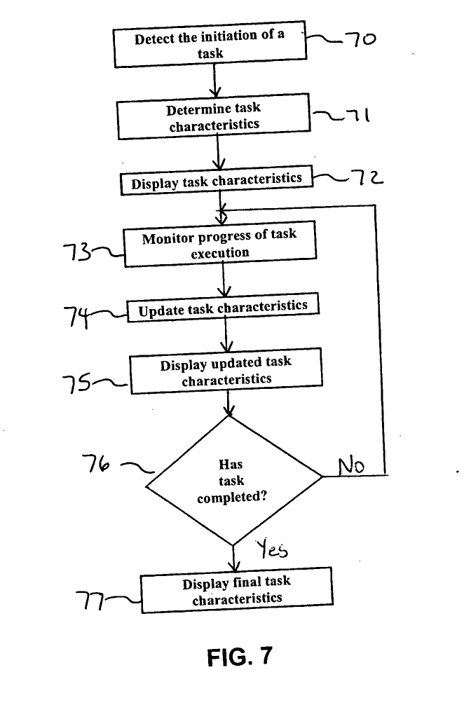

The method of the present invention is illustrated in FIG. 7. Shown is a flow diagram of the method for displaying information related to the status and completion of executing tasks in accordance with the present invention. These tasks would generally include system management tasks such as distributing certain software patches to various machines on the system, sending out scripts or transmitting commands sent out by the system administrator. Prior to the activation of this method, the system is placed in a monitor state. While in this monitor state, the initial step 70 detects the initiation of a task. Step 71 will determine the characteristics of that initiated task. The task characteristics could include the task name, the size of the task, the time required to fully perform that task and whether the task contains subtasks. Step 72 displays the initial status of the tasks in a completion results column 48 of the display such as shown in FIG. 4. After the completion of this initial task display step, the method moves to step 73, which monitors the progress of the task as it executes. This step receives processing information generated during the execution of the task to determine task execution status. The information could include error message generated during the task execution. For example, if a task attempted to run on a machine that did not have enough memory, this lack of memory space would generate an error message that would be captured by the monitoring step 73. This monitoring could include a periodic gathering of status information about a task or it could be a gathering in response to some event that occurred. The intent is to keep the information in the display of the task activity as close to real-time as possible. Step 74 updates the task status screen with current information about the executing tasks. Step 75 updates the screen display with the information gathered in steps 73 and 74. As with the monitoring step 74, step 75 can be a periodic update or the update could be in response the occurrence of an event. The manner of updating the display screen could vary and include other arrangements addition to the periodic or event drive approaches. Step 76 determines whether the task is completed. If so, the information for each task is displayed in a final display for that client in step 77. If the task is not complete, the process moves back to step 73 and monitoring processes repeats until the end of the task is determined.

The following example explains an implementation of the method described in FIG. 7. The system administrator initiates or schedules a task ‘ABCD’ to be executed on the computing system. This task could be a command to update the sales department directory on all department machines. Step 70 detects this task initiation. This detection can be the result of a monitoring activity in step 70 or a prompt could be sent to step 70 from a system monitor the could detect the initiation of the task on the system. Step 71 would determine the characteristics of task ‘ABCD’. In addition to the above-listed characteristics, the ABCD task could comprise four equal subtasks. In this example, the task would require performing this directory update on 15 machines. Step 72 would display task ABCD on the display as an entry in FIG. 4 with a task name ABCD. At this point, the task would be in a scheduled stage or would be beginning its execution. When the task begins to execute, step 73 would monitor the execution of the task to ensure that all machines would be updated. When a machine directory was successfully updated, a confirmation would get to the monitor program. Step 74 would update the task status information to indicate that a directory update has been successfully completed. Step 75 would display the update completion in the completion results field 48 for that task as shown in FIG. 4. If a machine did not have sufficient memory or was approaching it memory capacity or if there were some problem with the update, the display for step 75, may reflect this memory insufficiency by displaying a warning (yellow color in the status bar) that would indicate a problem with the update task. For this example, step 73 may receive a message indicating low memory in machine number 5. This information could be used to display a warning. If machine 5 had insufficient memory and the update to that machine failed, the display bar may indicate the failure with a black color. The current method to obtain this type of information related to the operation of the task is to retrieve the task log for this task. The user would then review the processing activities and draw conclusions about the performance of the task. The present invention performs this analysis in an automated and real-time fashion. After an update and display, step 76 determines if the task has completed execution. This completion function can be accomplished by detecting the last task to execute (the last machine to update). A counter or an end tag for the last subtask would indicate the completion of the task. At the completion of the task, the display shows the final display of the execution of that task.

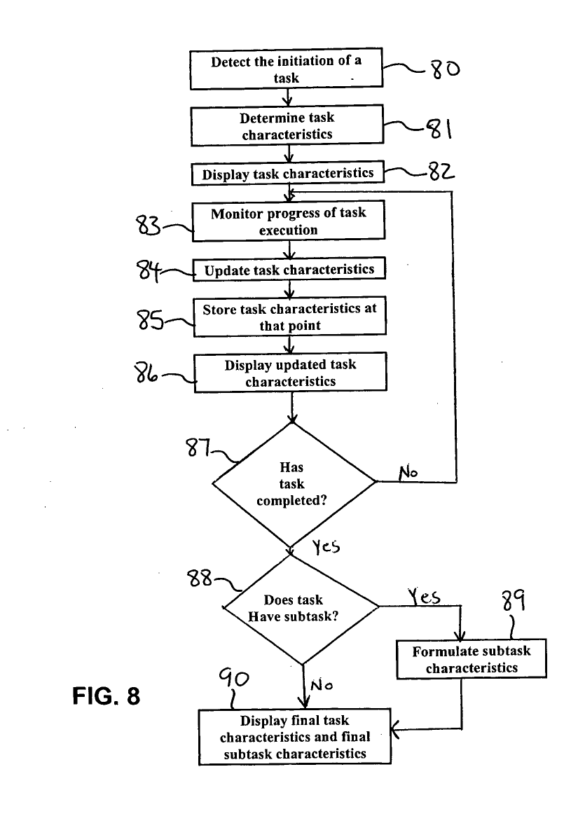

FIG. 8 is a flow diagram of an alternate implementation of the method described in FIG. 7. This alternate approach provides for the display of subtasks that are part of an executing task. For the above example, the updating of a machine directory would be a subtask. In that example, there would be 15 subtasks, one for each machine update. In FIG. 8, steps 80, 81, 82, 83 and 84 refer to the display of the overall task and correspond to steps 70, 71, 72, 73 and 74 of FIG. 7 respectively. Step 85 stores the information obtained during an update in step 84. Both the task and subtask information is stored in this step. Step 86, then displays this stored information as the current status of the executing task in the display shown in FIG. 4. The subtask information may not initially be displayed but can be included in a display format as shown in FIG. 5. However, this display is not automatically shown, but is displayed when user initiates a request to see the activity of a task. Step 87 determines whether the task has completed execution. As with FIG. 7, this determination is based on the initially determined characteristics of the task in step 81 which include task length. If at this point, the task has not completed execution, the method returns to step 83 for another monitoring session and repeats steps 83, 84, 85 and 86.

The determination of subtask activity can be performed as optional step 88. This approach is an alternative to the determination of subtask previously described in step 84. If the user only has the option of viewing subtask at the completion of the execution of the main, then the characteristics for the various tasks could be formulated in step 89. This step would not involve any intermediate determination of subtask status, only a final status determination. Step 90 would display the final status of the task.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links

We claim:

1. A method for displaying completion status of tasks initiated and executed in a computing environment comprising:
detecting the initiation of a task to be execution in the computing environment;
determining the characteristics of the initiated task;
monitoring the execution of the task;
periodically determining a status of the execution of the task by measuring characteristics of the task;
periodically recording the measured task characteristics as a current status of the task; and
displaying the task status as the current status of selected task characteristics.

2. The method as described in claim 1 wherein the characteristics of the initiated task can comprise the task name, task length, the start time of the task, and the identification of all subtask contained in the task.

3. The method as described in claim 1 further comprising before said displaying step, the step of storing the recorded measured task information.

4. The method as described in claim 1 further comprising the steps of:
storing status information of a specific task on a task details; and
displaying the stored status information of a specific task on a task details display screen.

5. The method as described in claim 1 wherein said monitoring step further comprises retrieving system information for the executing task.

6. The method as described in claim 5 wherein said monitoring step further comprises determining update status of task characteristics based on the information retrieved in said monitoring step.

7. The method as described in claim 1 wherein said periodic status detecting step further comprises retrieving system information for the executing task and determining update status of task characteristics based on the information retrieved in said monitoring step.

8. The method as described in claim 1 further comprising the steps of:
detecting the completion of the execution of a task; and
displaying a final task status of an executed task.

9. The method as described in claim 1 further comprising the steps of
determining whether a task has subtasks;
when there is a subtask, determining characteristics of the subtask;
formulating a status of a subtask at the completion of the task; and
displaying execution status of a subtask on a details task display.

10. A system for displaying completion status of tasks initiated and executed in a computing environment comprising:
a display showing statuses of tasks, said display comprising for one or more columns with each column display a characteristic of the status of a task;
a software monitor program installed in a computing system in which a task is executing or is scheduled to execute, said monitor program monitors the progression of the execution of a task in the computing environment;
a display program for displaying status information of a task executing on the computing system, the status information containing information indicating the percentage of successful execution of the task.

11. The system as described in claim 10 further comprising a detailed task display showing specific information a particular task on a page.

12. The system as described in clam 11 wherein said detailed task display comprises a section containing task details information, a section contains information on task jobs and a section containing information target systems information.

13. The system as described in claim 10 wherein one column of said display is a status completion column, said status completion column comprising a completion bar for each task listed in said display, the completion bar capable of indicating on the successful completion of a task.

14. The system as described in claim 10 wherein one column of said display is a status completion column, said status completion column comprising a completion bar for each task listed in said display, the completion bar capable of indicating places in the execution of the task where abnormal activity occurred.

15. The system as described in claim 10 wherein one column of said display is a status completion column, said status completion column comprising a completion bar for each task listed in said display, the completion bar capable of indicating on the completion of a task by illuminating portions of the completion bar with various colors, each such color corresponding to a predetermined completion status.

16. The system as described in claim 10 wherein one column of said display is a status completion column, said status completion column comprising a completion bar for each task listed in said display, the completion bar capable of indicating on the completion of a task by illuminating portions of the completion bar with various graphical patterns each such pattern corresponding to a predetermined completion status.

17. A computer program product in a computer readable medium for displaying completion status of tasks initiated and executed in a computing environment comprising:
instructions for detecting the initiation of a task to be execution in the computing environment;
instructions for determining the characteristics of the initiated task;
instructions for monitoring the execution of the task;
instructions for periodically determining a status of the execution of the task by measuring characteristics of the task;
instructions for periodically recording the measured task characteristics as a current status of the task; and
instructions for displaying the task status as the current status of selected task characteristics.

18. The computer program product as described in claim 17 wherein said periodic status detecting instructions further comprise instructions for retrieving system information for the executing task and determining update status of task characteristics based on the retrieved system information.

19. The computer program product as described in claim 17 further comprising instructions for:
detecting the completion of the execution of a task; and
displaying a final task status of an executed task.

20. The computer program product as described in claim 17 further comprising instructions for:
determining whether a task has subtasks;
when there is a subtask, determining characteristics of the subtask;
formulating a status of a subtask at the completion of the task; and
displaying execution status of a subtask on a details task display.
